(19) United States
(12) Patent Application Publication
(10) Pub. No.: US 2021/0344798 A1
(43) Pub. Date: Nov. 4, 2021

(54) INSURANCE INFORMATION SYSTEMS

(71) Applicant: Aadil GINWALA, Pittsburgh, PA (US)

(72) Inventor: Aadil GINWALA, Pittsburgh, PA (US)

(73) Assignee: WALLA TECHNOLOGIES LLC, Pittsburgh, PA (US)

(21) Appl. No.: 17/302,423

(22) Filed: May 3, 2021

Related U.S. Application Data
(60) Provisional application No. 63/018,915, filed on May 1, 2020.

(51) Int. Cl. H04M 3/493; G06Q 40/08; H04M 3/523; H04M 3/51; H04M 3/18; G06N 3/02

(52) U.S. Cl. CPC H04M 3/4936; G06Q 40/08; H04M 3/5232; H04M 3/5237; H04M 2203/2027; H04M 3/5191; H04M 3/18; G06N 3/02; H04M 3/5175

(57) ABSTRACT

Systems and methods for collecting and transmitting insurance data using an IVR system are described herein.

### CROSS-REFERENCE TO RELATED APPLICATIONS

This application claims priority from U.S. Provisional No. 63/018,915, entitled “Insurance Information Systems” filed May 1, 2020, the entirety of which is hereby incorporated by reference.

### GOVERNMENT INTERESTS

Not applicable

### PARTIES TO A JOINT RESEARCH AGREEMENT

Not applicable

### INCORPORATION OF MATERIAL ON COMPACT DISC

Not applicable

### BACKGROUND

Interactive voice response solutions use a variety of pre-recorded voice prompts and menus to present information and options to callers, and touch-tone telephone keypad entry to collect caller responses. Modern interactive voice response solutions enable input and responses to be gathered via spoken words with a variety of voice recognition techniques. Interactive voice response systems can respond with pre-recorded or dynamically generated audio messages to direct users on how to proceed. Interactive voice response systems, typically, include decision or flow trees specifying choices that can be taken when communicating with the interactive voice response system. Such interactive voice response solutions in the insurance industry enable users such policy holders, claimants and third parties to initiate, retrieve and access information including claim status, medical information, employee benefits, payments, and the like.

These decision trees are very convoluted and may be nested within a variety of other decision or flow trees. It would be desirable to have a system that could provide users with improved and streamlined interactive voice response system experiences especially in the insurance field.

### SUMMARY OF THE INVENTION

Various embodiments of the invention are directed to methods for collecting and transmitting insurance data. In some embodiments, the methods may include the steps of acquiring patient intake information; contacting an insurance provider; navigating a phone tree of the insurance provider system or accessing electronic information form; and completing an insurance claim or obtaining coverage information. In particular embodiments, such methods including the steps of acquiring patient intake information, contacting an insurance provider, navigating a phone tree of the insurance provider system or accessing electronic information form, and completing an insurance claim or obtaining coverage information may be carried out by a processor or a computer system programmed to perform such tasks.

In some embodiments, the methods may include the step of communicating with a human or “live” agent associated with the insurance provider system, and in some embodiments, such methods may include transferring a call to a human health care provider agent or a chatbot tool. Such methods may include the step of completing an insurance claim or obtaining coverage information. In certain embodiments, the methods may include the step of extracting necessary data or information from transcripts of a phone call, and in some embodiments, the methods may include providing required information to the healthcare provider.

Further embodiments are directed to a method for detecting a human voice including the steps of obtaining an audio recording, segmenting the audio recording into 3 to 5 second clips in which each segment begins at a time within the preceding segment to produce a series of overlapping audio clips, individually determining whether each of the overlapping audio clip is a recording of a human or a non-human audio recording, and classifying the audio recording as a human or a non-human audio recording when a plurality of the overlapping audio clips are classified as human. In various embodiments, the plurality of overlapping audio clips that are classified may be 2, 3, 4, 5, 6, 8, 10 or more audio claims, and the audio recording may be classified as human or non-human when at least 50%, 75%, 80%, 90%, or more are classified as human or non-human, respectively. In certain embodiments, classifying may be carried out on a subset of audio clips, and in some embodiments, classifying may be reiterated if the subset of audio clips is classified as not being human.

In some embodiments, the methods may further include extracting features from each of the overlapping audio clips, and in certain embodiments, extracting features is carried out by a processor. In some embodiments, the methods may include creating an audio embedding comprising a numeric representation of each of the overlapping audio clips, and in certain embodiments, the step of creating an audio embedding can be carried out by a neural network associated with a processor. In some embodiments, determining whether each of the overlapping audio clips is a recording of a human or non-human can be carried out by a neural network associated with a processor.

In particular embodiments, the step of obtaining an audio recording may include recording speech from a telephone call. In some embodiment, the methods may include transferring the telephone call to a human agent if the audio recording is classified as human. In certain embodiments, the methods may include processing and decompressing the audio recording to improve the signal to noise ratio. In some embodiments, the voice recording may be obtained from a health insurance IVR system.

The methods of various embodiments described above including the steps of obtaining, segmenting, determining, and classifying may be carried out by a processor. Each of the steps may be encoded by programming instructions that can be stored in memory of a device capable of communicating with a processor, and the instructions can be executed by the processor to produce the desired result. For example, a server may provide a computing device with programming instructions to carry out the methods of various embodiments described above in response to an incoming telephone call. Different devices may be operable using different sets of instructions, that is having one of a variety of different “device platforms.” Differing device platforms may result, for example and without limitation, to different operating systems, different versions of an operating system, or different versions of virtual machines on the same operating system. In some embodiments, devices are provided with some programming instructions that are particular to the device.

### DESCRIPTION OF THE DRAWINGS

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in details so as to not unnecessarily obscure the present invention.

FIG. 1 is a diagram showing an exemplary system for performing the methods discussed below.

FIG. 2 is a flowchart showing various systems and methods of the invention discussed below.

FIG. 3 is a flowchart showing an exemplary system for performing machine-to-machine chat as discussed below.

FIG. 4 is a flowchart showing an exemplary system for performing machine-to-human chat as discussed below.

FIG. 5 is a flowchart showing an exemplary method for answering questions using an NLP based system discussed below.

FIG. 6 is a flowchart showing an exemplary method for determining whether a caller is human as discussed below.

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 μm to 8 μm is stated, 2 μm, 3 μm, 4 μm, 5 μm, 6 μm, and 7 μm are also intended to be explicitly disclosed, as well as the range of values greater than or equal to 1 μm and the range of values less than or equal to 8 μm.

All percentages, parts and ratios are based upon the total weight of the topical compositions and all measurements made are at about 25° C., unless otherwise specified.

The singular forms “a,” “an,” and “the” include plural referents unless the context clearly dictates otherwise. Thus, for example, reference to a “polymer” includes a single polymer as well as two or more of the same or different polymers; reference to an “excipient” includes a single excipient as well as two or more of the same or different excipients, and the like.

The word “about” when immediately preceding a numerical value means a range of plus or minus 10% of that value, e.g, “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g, more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entirety are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

The following detailed description of example implementations refers to the accompanying drawings. The same reference numbers in different drawings may identify the same or similar elements.

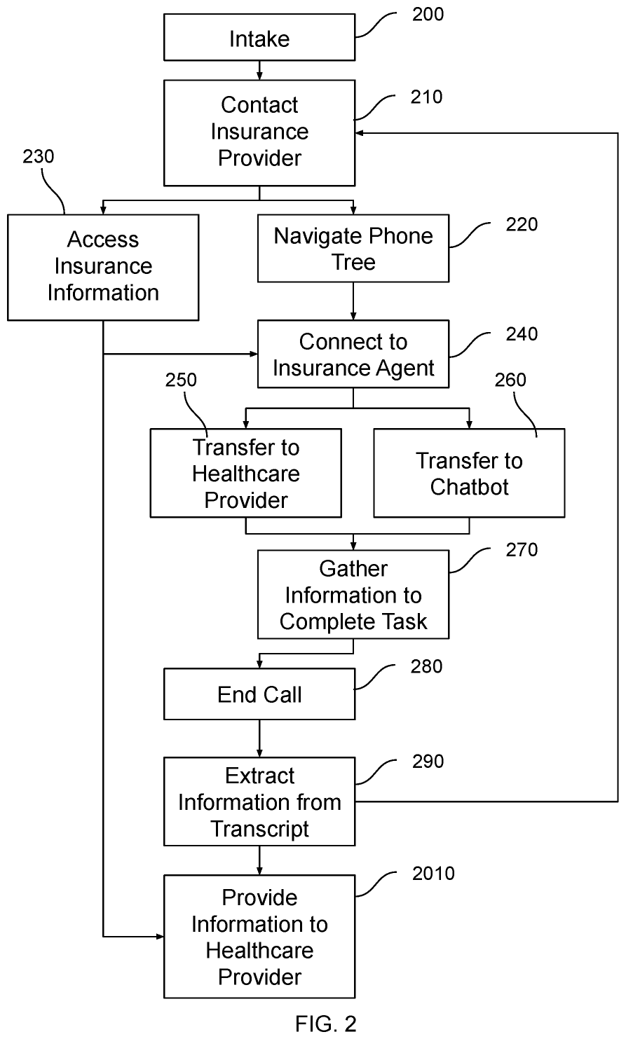

Embodiments of the invention include interactive voice response (“IVR”) systems for efficient handling and management of health insurance inquiries. In some embodiments, the systems may include an interface for communicating with medical insurance companies on behalf of medical providers, patients, other medical insurance companies, or combinations thereof. As illustrated in FIG. 2 the IVR system of various embodiments may acquire patient intake information 200, contact an insurance provider 210 by, for example dialing a phone number associated with an insurance provider or connecting with an insurance provider system using the internet, navigate a phone tree of the insurance provider system 220 or access electronic information from, for example, an insurance provider application programming interface (API) 230, communicate with a human or “live” agent associated with the insurance provider system 240, transfer a call to a human health care provider agent 250 or a chatbot tool 260 to obtain necessary information to accomplish a task, for example, completing an insurance claim or obtaining coverage information 270, end a telephone call 280, extract the necessary data or information from transcripts of the phone call 290, and provide required information to the healthcare provider 2010. Such information may be provided to the healthcare provider by, for example, an API call, data sheet, communications summary, completed forms, and the like or any combination thereof.

In some embodiments, the IVR system may be optimized for outbound calls in the medical insurance field, specifically for calls made from medical providers to medical insurance companies on behalf of medical providers or patients. Necessary information may include, for example, in order to whether a patient's insurance is active, covers a particular treatment (including medication, medical procedure, medical office visit, and the like) and required payments for the treatment, i.e. “benefit investigation” or “benefit verification” or whether a prior authorization or approval for a particular treatment is required, whether the prior authorization is on file, has been processed, and is active and what information and/or approvals should be obtained from the insurance provider system.

As used herein, the term “insurance provider” encompasses both private insurance providers such as, UnitedHealth, Kaiser Foundation, Anthem Inc., Humana, CVS, Health Care Service Corporation (HCSC), Blue Cross, Cigna, and the like, and public insurance providers, such as Medicare, Medicaid, CHIP, Veterans Administration, and the like. “Insurance provider” may also include various other health related payors relating to, for example, Short Term Disability, Long Term Disability, Workers' Compensation, and Family Medical Leave Act (FMLA) and the like.

In some embodiments, the IVR system may include acquiring intake data 200 in FIG. 2. Intake data can be acquired manually completing an intake form or by electronically accessing currently available patient information from a medical provider API or by scrapping patient information from, for example, electronic charts. In some embodiments, acquiring intake data may also include verifying available patient information. Intake data may include any patient specific information necessary to navigate an insurance provider IVR and/or complete a chatbot conversation with an insurance provider agent or chatbot. For example, intake data may include, for example, the patient's name, the patient's DOB, the patient's insurance provider, phone numbers for the patient and insurance provider, insurance card numbers, social security numbers, billing physician's name, National Provider Identifier (NPI) number, and/or TaxID number, primary care provider's name, NPI number, and/or TaxID number, that doctor's NPI and/or Tax ID, JCODE for medications, Current Procedural Terminology (CPT) codes, and the like and combinations thereof. Intake information may be compiled and stored for individual patients. Thus, in some embodiments, the step of acquiring intake data may be omitted if the IVR system has access to complete and verified patient intake data is complete, or the step of acquiring intake data may include verifying available patient data.

In some embodiments, acquiring intake data may include validating the format of the intake data. Validating the format of the intake data ensures that the IVR system has sufficient information to navigate the phone tree of the insurance provider identified in the intake data. If the system does not have sufficient insurance provider information or there are errors in the intake data, in some embodiments, the IVR system may repeat the step of acquiring intake data identifying information to be provided by the patient or healthcare provider, or in other embodiments, the IVR system may add the intake data to a queue from which the healthcare provider will collect necessary information or carry out a call to the insurance provider manually.

In some embodiments, acquiring intake data may further include accessing insurance information electronically. For example, the IVR system may be in communication with an insurance claims system or claim initiation subsystem. The insurance claims system or claim initiation subsystem may provide prompts for the IVR system to provide medical data such as, medical judgment and evaluation data, patient data, insurance data, or any information related to the healthcare provider's treatment of the patient. After providing the intake data to the insurance claims system or claim initiation subsystem, the IVR may provide claim related information to the healthcare provider If additional intake data is necessary, the IVR system may provide the information to an API, a web-based summary of benefits form or spreadsheet, or complete necessary forms or provide the information in any other desired delivery format. If additional information is necessary to complete the claim, the IVR system may return the intake data and acquired information to a master queue and recontact the insurance provider by a different method to retrieve missing information. In some embodiments, a modified logic script may be created to ensure the IVR system asks for the missing information. In other embodiments, the IVR system may introduce the intake data and acquired information into a healthcare provider queue to be forwarded to human healthcare provider agents who will complete the claim by calling the insurance provider.

If the intake data is correct and the IVR system has sufficient information to navigate the phone tree of the insurance provider, the IVR system may contact the insurance provider 210. In some embodiments, contacting the insurance provider can be carried out electronically by, for example, accessing an insurance provider API 230. In other embodiments, the IVR system may call the insurance providers via telephone and navigate the insurance provider phone tree 220. For example, when the insurance provider system asks a question, the question may be translated into text by the IVR system. The IVR system may be pre-programmed to respond to specific questions with static answers such as say “provider” or press 2 when the insurance provider system asks who is making the call. In some embodiments, the IVR system may be pre-programmed to respond to dynamic questions, such as, “patient's date of birth” by speaking the patient's date of birth as provided in the intake data or keying in the numbers associated with the patient's date of birth. As suggested above, the IVR system may provide required information using text-to-speech algorithms, such as, Amazon Polly or Lex, or by using a number tone for keyed inputs. When the answer is then received by the insurance provider system, the insurance provider system may ask another question, which the IVR system will answer using the same techniques. Table 1 provides a list of example questions commonly incorporated into an insurance providers phone tree.

TABLE 1
Common Insurance Provider Questions
Is the physician in or out of network?
Are you the patient's primary insurer?
What type of plan? (HMO, PPO, Medicare Adv)
Insurance effective date
Insurance renewal/term date
Group number
What is the Specialist copay amount?
What is the deductible?
How much of the deductible has been met as of today's date?
What is the OOPM?
Does the OOPM include the deductible?
Is the OOPM/deductible on a calendar year?
Can the physician's office buy & bill?
Must this be filled at a Specialty Pharmacy (white-bag)?
If yes, what Specialty Pharmacy is preferred?
What is the plan coverage for this drug?
What is the copay for this drug?
What is the coinsurance for this drug?
Other requirements for coverage?
Are there quantity/dose/unit restrictions?
Is a PA required for this drug?
What are the PA requirements?
Is a PA currently on file?
What is the authorization number?
PA effective date
PA term date
Number of units covered on active PA
What is the coverage % for CPT administration code?
What is the plan coverage for this CPT administration code?
What is the copay for this CPT administration?
What is the coinsurance for this CPT administration?
Is PA required for administration of drug?
What are the PA requirements for administration?
Is a PA currently on file for administration?
What is the administration authorization number?
Administration PA effective date
Administration PA term date
Representative name
Call reference number

A typical insurance provider call includes about 40 questions and can take 15 to 30 minutes. Eliminating human interaction from this process can more than double the productivity of the medical provider staff people responsible for making these calls.

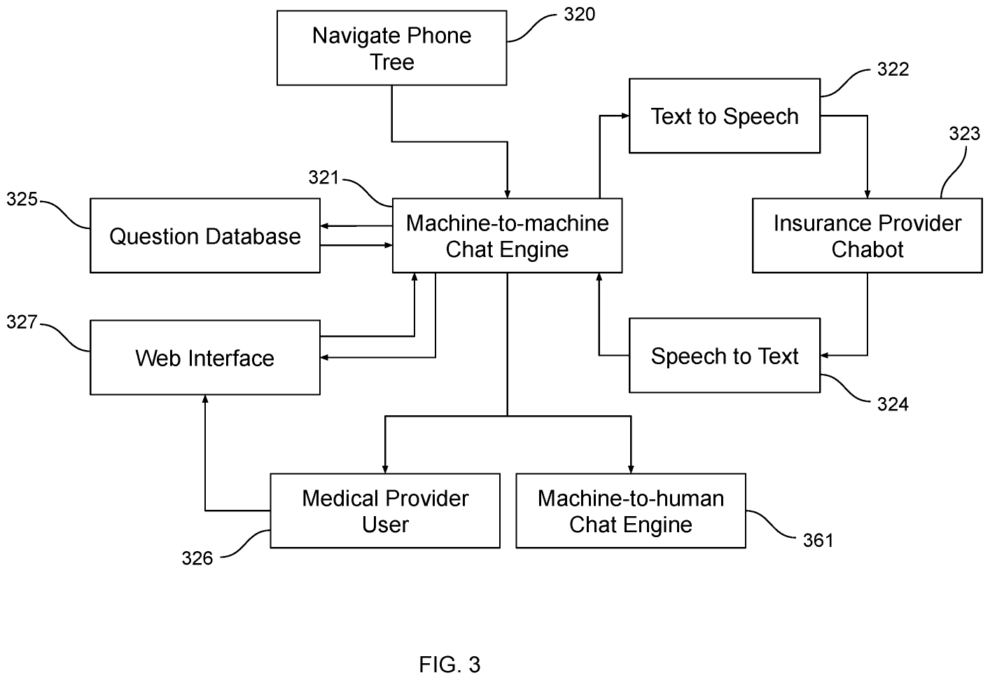

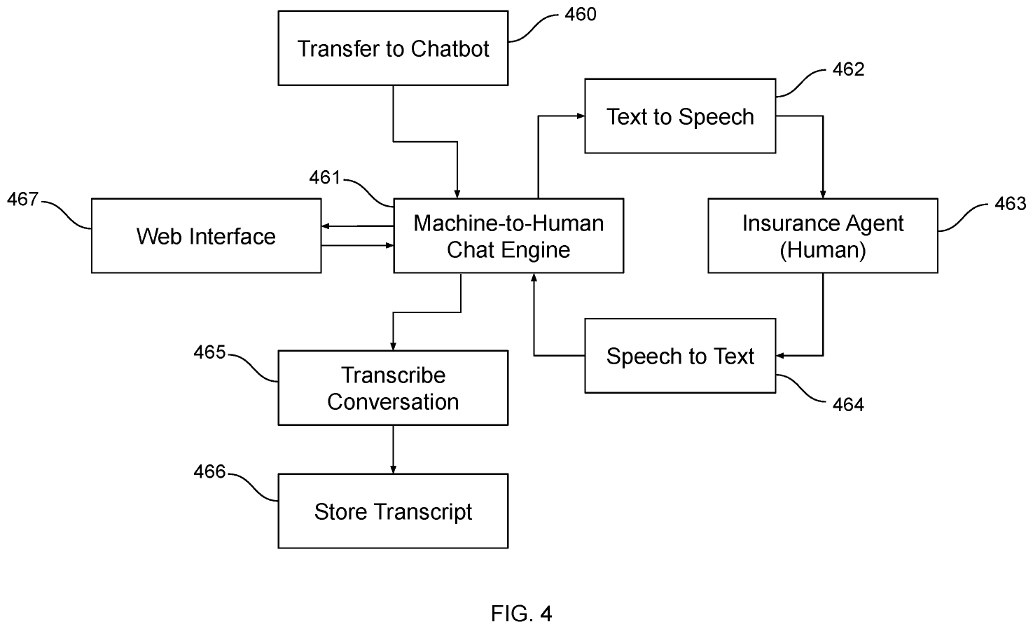

In some embodiments, a chatbot-chatbot chat engine may be used to navigate a phone tree. As illustrated in FIG. 3, when a call has been made to an insurance provider and phone tree questions are begun, the IVR system may use a machine-to-machine chat engine 321 to navigate the phone tree. A “phone tree” is typically an insurance provider chatbot that asks basic questions required for most insurance inquiries before initiating a call with an insurance agent. The machine-to-machine chat engine 321 may receive questions from an insurance provider chatbot 323 after a speech to text 324 translator has converted the question to text. The machine-to-machine chat engine 321 may query a question database 325 for the answer to the insurance provider chatbot 323 question, or the machine-to-machine chat engine 321 may query a intake data from the web interface 327 for the answer. Once the answer is retrieved a text-to-speech translator 322 converts the answer into speech and responds to the insurance provider chatbot 323. This loop is repeated until all of the insurance provider chatbots 323 questions are answered at which point the machine-to-machine chat engine 321 may transfer the call to the medical provider user (human) 326 or a machine-to-human chat engine 361 to complete the call with a human insurance agent. The machine-to-human chat engine 361 is further discussed below and in FIG. 4.

When all of the programmed questions in the insurance provider system have been answered, the call may be placed on “hold” while the insurance provider system connects the IVR system to a human insurance agent. In some embodiments, the IVR system may wait on hold for a defined amount of time, which the users can set or program as part of the intake data and then transfer the call to a number where a healthcare provider user or live agent can take the call 150. In such embodiments, the IVR system may transmit the intake data to the healthcare provider when the call is transferred. In other embodiments, the IVR system may transfer the call to a chatbot or digital assistant 260, which can answer insurance agent questions and collect necessary information. In further embodiments, the IVR system may transfer the call to a chatbot or digital assistant, where questions are answered and the call may be transferred to a human healthcare provider during the interaction with the insurance agent if necessary.

In some embodiments, the IVR system may stream the entire contents of the call to a speech-to-text recognition engine, the system may commence recording the call, or combinations thereof when the insurance provider system begins the phone tree interaction. In other embodiments, speech-to-text recognition engine, recording the call, or combinations thereof may be carried out when an insurance agent.

In embodiments in which a chatbot is used 260, the chatbot may conduct a conversation with the human insurance agent, or another digital “bot” insurance agent, using voice streaming, speech-to-text, and text-to-speech translation tools. The chatbot may include a logic engine that allows the chatbot to decide what to say or ask the human or bot insurance agent, listen to the human or bot insurance agent's response, process the information disclosed in the response, and ask the next question, reply to the question/statement made by the human or bot insurance agent, or ask for clarification or confirmation. The chatbot may ask all necessary and relevant questions to gather the full and complete information needed for a task 270 such as, for example, investigating benefits, verifying a specific patient and a specific treatment, and the like and combinations thereof.

FIG. 4 illustrates an example of a chatbot that can engage a human insurance agent (machine-to-human chat engine 461). When the IVR system transfers the call to the chatbot 460, the machine-to-human chat engine 461 may be activated and acquire the intake data from the IVR system web interface 467. When an insurance agent 463 asks as question, the chatbot may translate the speech to text 464 submit the query to the machine-to-human chat engine 461, which queries the intake data for the answer, and transmits the answer to a text to speech engine 462, which provides the answer to the human agent 463. This feedback loop is repeated until all of the insurance agents questions have been answered or the query cannot be answered with the intake data. At which point, the machine-to-human chat engine may forward the call to a human medical provider to answer the question. Upon completion, the machine-to-human chat engine may create a transcript of the entire conversation 465 and store the transcript 466 for further processing, such as identifying questions that could not be answered and updating the intake data to include the question for the all intake forms or intake forms for the specific insurance provider.

In some embodiments, the IVR system may use natural language processing to create and parse a transcript of the conversation and extract the relevant data required to complete the task when the call is completed. If the call was successful, i.e. the necessary information was acquired during the call, the IVR system may provide the information to an API, a web-based summary of benefits form or spreadsheet, or complete necessary forms or provide the information in any other desired delivery format. If the call was not successful, i.e. all the required information is not captured, the IVR system may return the intake data and acquired information to a master queue and recontact the insurance provider to retrieve missing information. In some embodiments, a modified logic script may be created to ensure the IVR system asks for the missing information. In other embodiments, the IVR system may introduce the intake data and acquired information into a healthcare provider queue to be forwarded to human healthcare provider agents who will complete the call. In further embodiments, the intake data and acquired information may be entered into a healthcare provider queue, if the IVR system is unsuccessful at retrieving the necessary information after several, for example, 3, attempts.

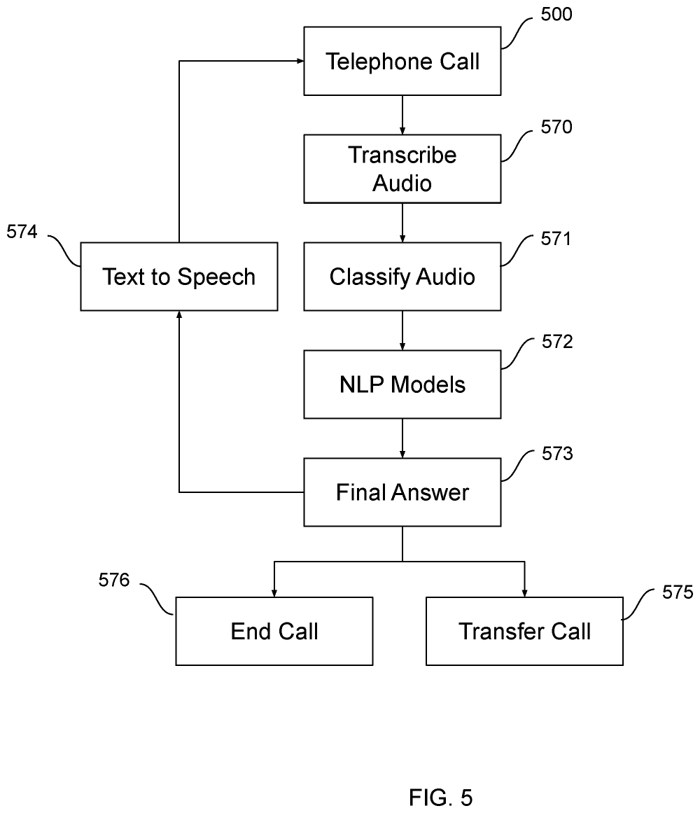

Further embodiments are directed to methods for processing questions using an NLP based system. Questions requesting information for providers can be phrased in various ways. To answer the questions properly, the system must recognize what information is being requested regardless of the phrasing of the question. Embodiments of the invention include methods as illustrated in FIG. 5 to answer questions regardless of phrasing.

As illustrated in FIG. 5, the system may transcribe recorded audio 570 from the call 500. In some embodiments, the transcribed audio may be classified 571. The classifying step can be carried out by various means. For example, in some embodiments, classifying can be carried out using a pre-trained model such as BERT or GP-2. Bidirectional Encoder Representations from Transformers (BERT) is designed to pre-train deep bidirectional representations from unlabeled text by jointly conditioning on both left and right context. The pre-trained BERT model can be fine-tuned with additional output layers to create a model that classifies questions into one or more classes. The number of classes may vary based on the complexity and number of questions commonly asked during the call for information. For example, classifying 571 may classify audio transcripts into about 5 to about 100, about 5 to about 50, about 5 to about 25, about 5 to about 20 classes, or number of classes encompassed by these example ranges. The classified audio may then be passed to an NLP model or series of NLP models 572 that use the classified question to produce a final answer 573. The NLP models may find a final answer 573 by comparing the audio to previously answered questions of the same classification, or provide a final answer 573 based on the classification. In some embodiments, the NLP models may formulate an answer using the terminology of the original question, ensuring that the answer is accepted by the questioner. If an answer can be provided, the answer may be passed from the NLP model to a text to audio translator 574 and transmitted through the telephone to the provider. If an answer cannot be provided, the system may transfer the call to a human 575, who is capable of answering the question, or end the call 576. In some embodiments, the system may classify audio text indicating that all necessary information had been provided and end the call.

In various embodiments, the IVR system may be cloud-deployed and/or cloud-based, and fully HIPAA secure and compliant.

It also has a queuing and data validation tool at the “front” of the process that takes in both new call requests and returned call requests for unsuccessful calls. The tool checks each requested call to ensure the data supplied is not missing a necessary field, is in the correct format, and is for a number that has an IVR-tree programmed. Any that fail those checks is sent to a correction queue for fixing. The rest are dynamically allocated across the available phone lines and call engines, such that each line is supplied with and making a new call once its last call is finished.

Additional embodiments are directed to methods and systems for detecting a human voice. In some cases, patient or payer information may be requested by a human being. The IVR systems of some embodiments may detect a human voice and transfer the call to a human agent. Callers 680 may speak very few words when announcing the purpose for their call, and telephone communications may suffer from various forms of interference and audio issues such as low volume, garbled audio, static, and the like. Therefore, the IVR system must be capable of detecting a human based on very short audio clips that can be low quality.

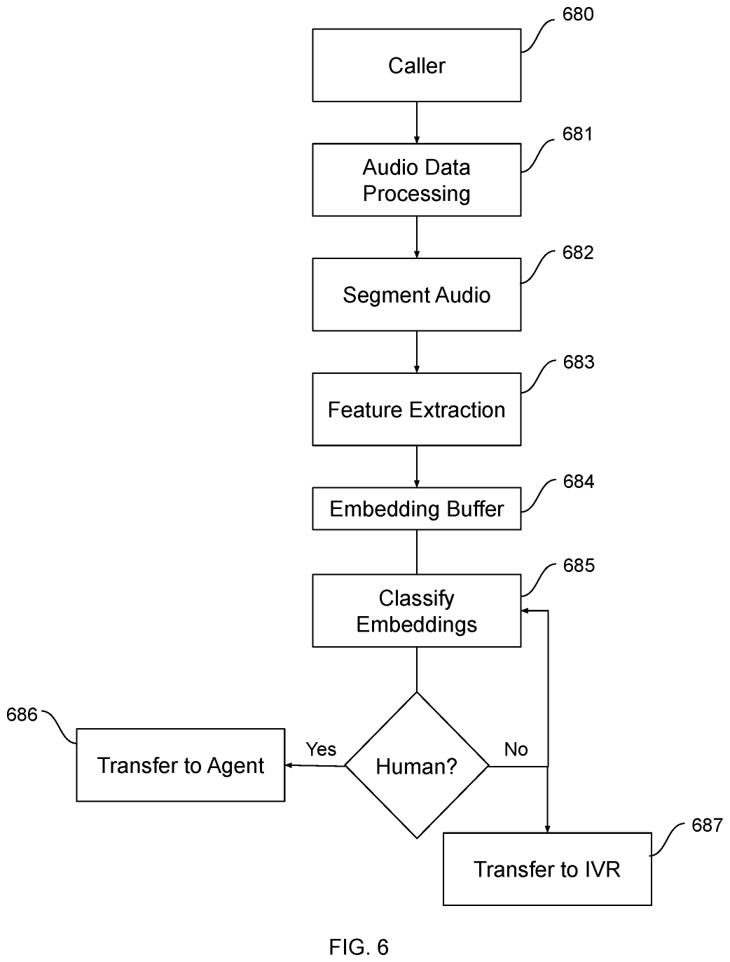

An example of such systems is provided in FIG. 6. In such embodiments, the audio may be processed and decompressed 681 to improve the quality of the audio. For example, a companding algorithm such as, μ-law or A-law, can be used to reduce the dynamic range of the audio signal and increase the signal-to-noise ratio. The audio may then be segmented 682 into 3 to 5 second clips. In some embodiments, the clips may be shifted by one second to produce a series of overlapping clips that can be individually processed. Shifting increases the number of audio clips. Each of the processed audio clips can undergo feature extraction 683. Feature extraction 683 can be carried out using a number of computational methods and can be performed by adopting extraction according to a frequency and amplitude or by adopting linear predictive coding (LPC). For example in some embodiments, a neural net such as a VGGish model can be used to generate a series of features associated with each clip. The extracted features can be used to create an audio embedding, a numeric representation of the audio clips that can be classified. After feature extraction 683, the resulting audio clip embeddings may be passed to a buffer 684.

Classifying the audio embeddings 685 can be carried out by various means. For example in some embodiments, a neural net, such as an attention model can be used to classify each of the clips by enhancing the important parts of the input data and fading out the rest. In some embodiments, the classifying step can be carried out using at least 4 overlapping audio clips. In such embodiments, at least 3 of the at least 4 overlapping audio clips can be encoded to create a context vector. At least one of the at least four overlapping audio clips can be used in a decoder step that is compared to the context vector. This process results in a classification of the decoder audio clip as being generated by a human speaking into the telephone or a computer voice simulator, i.e. not human. The classifier may perform these steps iteratively on each set of embeddings for the overlapping audio clips until each of the clips have been classified. In some embodiments, the system may determine that the caller is human or not human based on a probability calculated from the classified audio clips. In other embodiments, the system may determine that a caller is human or not human when a number of consecutive audio clips, e.g. 3, 4, 5, or 6 consecutive audio clips, are classified as human or not human. In some embodiments, the classifier may classify a subset of audio clips, and reiterate the process if the caller is determined not to be human to verify this classification.

After classifying the audio clips as human, the system may transfer the call to a human representative 686 to complete the call. If the caller is determined not to be human, the system may end the call or transfer the call to an IVR system 687 for further processing.

The various steps of the systems and methods described above can be carried out by a processor. For example, embodiments include converting, by a processor, each word of each sentence of a document to a mathematical expression to produce a number of word mathematical expressions, combining, by a processor, the word mathematical expressions of a sentence to produce a sentence mathematical expression, and in some embodiments, combining, by a processor, each sentence mathematical expression of a paragraph to produce a paragraph mathematical expression for each paragraph of the document, combining, by a processor, each paragraph mathematical expression of a section to produce a section mathematical expression, combining, by a processor, each paragraph mathematical expression or section mathematical expression of the document to produce a document mathematical and so on. Thus, the steps of the methods of some embodiments can be carried out by a processing system or computer.

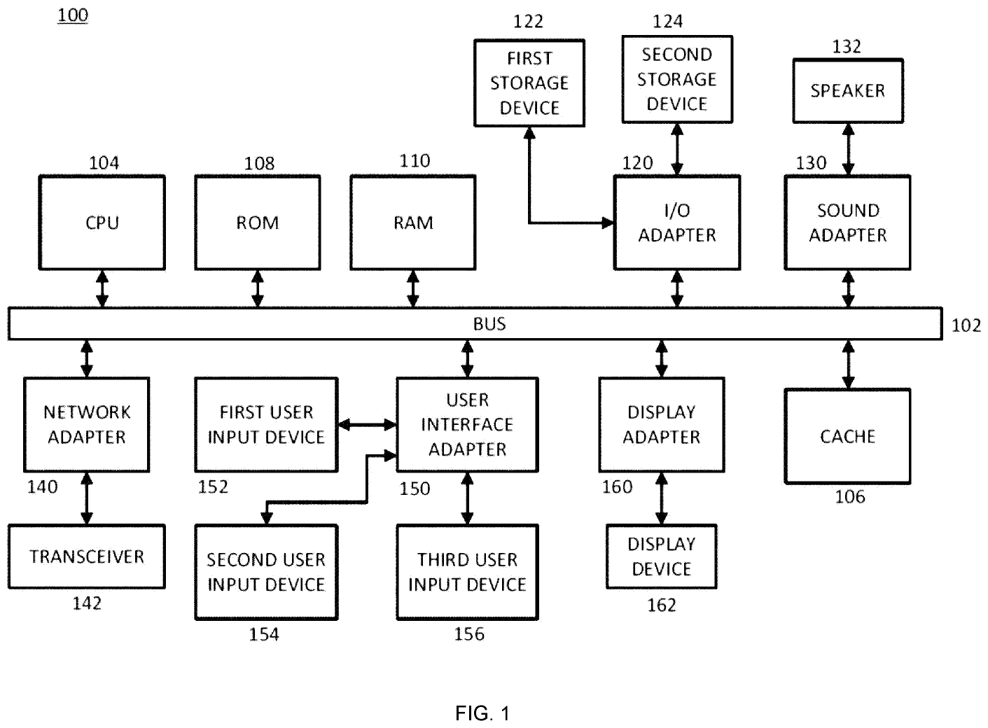

FIG. 1 is an exemplary processing system 100, to which the methods of various embodiments can be applied. The processing system 100 may include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, can be operatively coupled to the system bus 102.

A first storage device 122 and a second storage device 124 can be operatively coupled to system bus 102 by the I/O adapter 120. The storage devices 122 and 124 can be any of storage device, for example, a magnetic or optical disk storage device, a solid state magnetic device, and the like or combinations thereof. Thus, storage devices 122 and 124 can be the same type of storage device or different types of storage devices.

In some embodiments, a speaker 132 may be operatively coupled to system bus 102 by the sound adapter 130. A transceiver 142 may be operatively coupled to system bus 102 by network adapter 140. A display device 162 can be operatively coupled to system bus 102 by display adapter 160.

In various embodiments, a first user input device 152, a second user input device 154, and a third user input device 156 can be operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

The processing system 100 may also include numerous other elements that are not shown, as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

A variety of communications protocols may be part of the system, including but not limited to: Ethernet, SAP, SAS™, ATP, Bluetooth, GSM and TCP/IP. Network 406 may be or include wired or wireless local area networks and wide area networks, and over communications between networks, including over the Internet. One or more public cloud, private cloud, hybrid cloud and cloud-like networks may also be implemented, for example, to handle and conduct processing of one or more transactions or calculations of embodiments of the present invention. Cloud based computing may be used herein to handle any one or more of the application, storage and connectivity requirements of embodiments of the present invention. Furthermore, any suitable data and communication protocols may be employed to accomplish the teachings of the present invention.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for detecting a human voice comprising:
obtaining an audio recording;
segmenting the audio recording into 3 to 5 second clips wherein each segment begins at a time within the preceding segment to produce a series of overlapping audio clips;
individually determining whether each of the overlapping audio clip is a recording of a human or a non-human audio recording;
classifying the audio recording as a human or a non-human audio recording when a plurality of the overlapping audio clips are classified as human.

2. The method of claim 1, further comprising extracting features from each of the overlapping audio clips.

3. The method of claim 2, wherein extracting features is carried out by a computer.

4. The method of claim 1, further comprising creating an audio embedding comprising a numeric representation of each of the overlapping audio clips.

5. The method of claim 5, wherein creating an audio embedding is carried out by a neural network.

6. The method of claim 1, wherein determining whether each of the overlapping audio clips is a recording of a human or non-human is carried out by a neural network.

7. The method of claim 1, wherein obtaining an audio recording comprises recording speech from a telephone call.

8. The method of claim 6, further comprising transferring the telephone call to a human agent if the audio recording is classified as human.

9. The method of claim 1, wherein each of the steps of obtaining, segmenting, determining, and classifying is carried out by a processor.

10. The method of claim 1, wherein classifying is carried out on a subset of audio clips.

11. The method of claim 10, wherein classifying is reiterated if the subset of audio clips is classified as not being human.

12. The method of claim 1, further comprising processing and decompressing the audio recording to improve the signal to noise ratio.

13. The method of claim 1, wherein the voice recording is obtained from a health insurance IVR system.

14. A method for collecting and transmitting insurance data, comprising:
acquiring patient intake information;
contacting an insurance provider;
navigating a phone tree of the insurance provider system or accessing electronic information form; and
completing an insurance claim or obtaining coverage information.

15. The method of claim 14, further comprising communicating with a human or “live” agent associated with the insurance provider system.

16. The method of claim 14, further comprising transferring a call to a human health care provider agent or a chatbot tool.

17. The method of claim 14, further comprising completing an insurance claim or obtaining coverage information.

18. The methods of claim 14, further comprising extracting the necessary data or information from transcripts of a phone call.

19. The methods of claim 14, further comprising providing required information to the healthcare provider.

20. The method of claim 14, wherein each of the steps of acquiring, contacting, navigating, and completing are carried out by a processor.
